(19) United States
(12) Patent Application Publication
(10) Pub. No.: US 2012/0082711 A1
(43) Pub. Date: Apr. 5, 2012

(54) ANTIMICROBIAL COMPOSITIONS AND FIBRES INCORPORATING THE SAME

(76) Inventor: Konstantin Goranov, Atkinson, NH (US)

(21) Appl. No.: 12/675,336

(22) PCT Filed: Aug. 29, 2008
(86) PCT No.: PCT/CA08/01550

§ 371 Date: Dec. 10, 2010

Related U.S. Application Data
(60) Provisional application No. 60/969,350, filed on Aug. 31, 2007.

(51) Int. Cl. A01N 59/16; D04H 3/16; B29B 15/00; A01N 25/34; A01P 1/00

(52) U.S. Cl. 424/404; 424/618; 264/5; 156/167

(57) ABSTRACT

The present application defines an antimicrobial composition comprising (a) at least two antimicrobial agents having different antimicrobial mechanisms of action and being present in amounts that together provide a synergistic antimicrobial effect or (b) an antimicrobial agent and a surface modifying agent, an antimicrobial masterbatch comprising antimicrobial composition (a) or (b) and a polymer carrier, an antimicrobial fibre composition comprising the antimicrobial masterbatch and a fibre substrate, an antimicrobial fibre comprising a fibre body or a fibre surface having the antimicrobial fibre composition, and a process for producing antimicrobial fibres.

### FIELD OF INVENTION

The present invention concerns antimicrobial compositions and fibres incorporating the same.

### BACKGROUND OF THE INVENTION

Currently existing antimicrobial filter products, such as air filters and face masks, are made from filter media comprising a web of fibres and include a bioactive agent applied topically to the filter media to capture and kill pathogenic microbes. However, none of these bioactive agents individually demonstrate a broad spectrum of activity. This is especially true in the case of air filtration, particularly when the level of pathogen contamination during sporadic outbreaks is relatively high and reaches infectious levels.

Also, due to uncontrolled release processes on the filter media surface during normal use, the bioactive agents are limited in effectiveness as they do not take into account time delays related to human physiology and pathogen metabolism. In some cases, the protective device may become a source of infection outside the contaminated environment and thus, create an epidemic situation. Therefore, existing filter media based on single antimicrobial agents for face masks and air filters do not provide the required timely bio-efficacy or reliable protection.

Thus there is a need for an improved antimicrobial composition and fibrous filter material with antimicrobial properties.

### SUMMARY OF THE INVENTION

It is an object of the present invention to provide an improved antimicrobial composition for incorporation into fibres and fibrous filter material.

The present invention reduces the difficulties and disadvantages of the aforesaid designs by providing, from one aspect, an antimicrobial composition comprising a first antimicrobial agent capable of releasing a metal ion, and a second antimicrobial agent, the first and second antimicrobial agents being in amounts that together provide a synergistic antimicrobial effect.

From another aspect, there is provided an antimicrobial composition comprising at least two antimicrobial agents having different antimicrobial mechanisms of action and being present in amounts that together provide a synergistic antimicrobial effect.

The at least two antimicrobial agents can comprise a first antimicrobial agent which is organic and a second antimicrobial agent which is inorganic, alternatively or in addition to which the at least one of the first or the second antimicrobial agents can be a metal ion releasing agent.

In one embodiment of both these antimicrobial composition aspects, the first antimicrobial agent comprises about 5 to about 95% by weight silver-zinc-glass and the second antimicrobial agent comprises about 5 to about 95% by weight Triclosan™. More preferably, the composition comprises about 60% by weight silver-zinc-glass and about 40% by weight Triclosan™. Other antimicrobial agents in different proportions are also possible.

Optionally, the antimicrobial composition can further comprise a hydrophilic surface modifying agent, such as Irgasurf™ HL560. In this embodiment, the antimicrobial composition can comprise about 5 to about 99.9% by weight of the first and second antimicrobial agents together and about 0.1 to about 95% by weight of the hydrophilic surface modifying agent.

From yet another aspect, there is provided an antimicrobial composition comprising an antimicrobial agent and a hydrophilic surface modifying agent. The antimicrobial agent can be one which is capable of releasing a metal ion, such as silver-zinc-glass, or be any other type of antimicrobial agent, such as Triclosan™.

In one embodiment of this antimicrobial composition, there is provided about 5 to about 95% by weight of the surface modifying agent and about 5 to about 95% by weight of the antimicrobial agent; preferably about 15 to about 20% of the antimicrobial agent and about 80 to about 85% of the surface modifying agent.

In another aspect of the invention, there is provided an antimicrobial masterbatch for making antimicrobial polymers such as antimicrobial polymer fibres, the masterbatch comprising a polymer carrier, a first antimicrobial agent capable of releasing a metal ion, and a second antimicrobial agent, the first and second antimicrobial agents being in amounts that together provide a synergistic antimicrobial effect. By masterbatch it is meant an antimicrobial composition concentrate which can be added to a substrate to make fibres, for example.

In yet another aspect, there is provided an antimicrobial masterbatch for making antimicrobial polymers, the masterbatch comprising a polymer carrier, and at least two antimicrobial agents having different antimicrobial mechanisms of action and being present in amounts that together provide a synergistic antimicrobial effect. The at least two antimicrobial agents may comprise a first antimicrobial agent which is organic and a second antimicrobial agent which is inorganic. At least one of the first and second antimicrobial agents may be a metal ion releasing agent.

In one embodiment of the two abovementionend antimicrobial masterbatch aspects, the masterbatch may comprise about 2.5 to about 35.0% by weight of the first antimicrobial agent, about 2.5 to about 35% by weight of the second antimicrobial agent, and about 95% to about 30% by weight of the polymer carrier. Preferably, the composition of the masterbatch is about 5% by weight of the first antimicrobial agent, about 5% by weight of the second antimicrobial agent, and about 90% by weight of the polymer carrier.

The antimicrobial masterbatch may further comprise a hydrophilic surface modifying agent and the masterbatch composition may comprise about 2.5 to about 35% by weight of the first antimicrobial agent, about 2.5 to about 35% by weight of the second antimicrobial agent, about 5 to 45% by weight of the hydrophilic surface modifying agent, and about 50% to about 95% by weight of the polymer carrier. Preferably, the masterbatch comprises about 6.5% by weight of the first and second antimicrobial agents, about 35% by weight of the hydrophilic surface modifying agent, and about 58.5% of the polymer carrier.

The polymer carrier may comprise polypropylene, the first antimicrobial agent silver-zinc-glass and the second antimicrobial agent Triclosan™. The surface modifying agent may be Irgasurf™ HL560.

From a yet further aspect, there is provided an antimicrobial masterbatch for making antimicrobial polymers, the masterbatch comprising an antimicrobial agent, a hydrophilic surface modifying agent and a polymer carrier. The antimicrobial agent is preferably capable of releasing a metal ion and can be silver-zinc-glass, for example. Alternatively, the antimicrobial agent comprises Triclosan™.

In one embodiment, the antimicrobial masterbatch comprises about 5 to 45% by weight of the hydrophilic surface modifying agent, about 5 to 70% by weight of the antimicrobial agent, and about 50 to 90% by weight of the polymer carrier, preferably 35% by weight of the hydrophilic surface modifying agent, about 7% by weight of the antimicrobial agent, and about 52% by weight of the polymer carrier.

From another aspect, there is provided an antimicrobial fibre composition for making antimicrobial fibres, the composition comprising an antimicrobial masterbatch including at least two antimicrobial agents and a polymer carrier but without a surface modifier, as defined above, and a polymer substrate. In one embodiment, there is provided about 1 to 20% by weight of the antimicrobial masterbatch, and about 80 to 99% by weight of the polymer substrate, preferably about 5% by weight of the antimicrobial masterbatch, and about 95% by weight of the polymer substrate.

The antimicrobial fibre composition may further comprise a hydrophilic surface modifier. In this case, the antimicrobial fibre composition comprises about 1 to 20% by weight of the antimicrobial masterbatch, about 1 to 15% by weight of the hydrophilic surface modifier, and about 98 to 65% by weight of the polymer substrate, preferably about 5% by weight of the antimicrobial masterbatch, about 3% by weight of the hydrophilic surface modifier, and about 92% by weight of the polymer substrate.

In another embodiment, the antimicrobial fibre composition for making antimicrobial fibres comprises an antimicrobial masterbatch and a polymer substrate, wherein the masterbatch comprises at least two antimicrobial agents, a surface modifying agent and a polymer carrier, as defined above. In this case, the antimicrobial fibre composition comprises about 1 to 35% by weight of the antimicrobial masterbatch, and about 99 to 65% by weight of the polymer substrate, preferably about 8% by weight of the antimicrobial masterbatch, and about 92% by weight of the polymer substrate.

In yet another embodiment, the antimicrobial fibre composition for making antimicrobial fibres comprises an antimicrobial masterbatch and a polymer substrate, wherein the masterbatch comprises an antimicrobial agents and a surface modifying agent and a polymer carrier, as defined above. In this case, the antimicrobial fibre composition comprises about 1 to 30% by weight of the antimicrobial masterbatch, and about 99 to 70% by weight of the polymer substrate, preferably about 8% by weight of the antimicrobial masterbatch, and about 92% by weight of the polymer substrate.

From a yet further aspect of the invention, there is provided an antimicrobial fibre comprising a fibre body or a fibre surface having an antimicrobial fibre composition as defined above.

From another aspect, there is also provided an antimicrobial filter media comprising a web of antimicrobial fibres having an antimicrobial fibre composition as defined above, and a face mask comprising a plurality of layers of the antimicrobial filter media. In the face mask, at least two of the layers can comprise the same or a different antimicrobial fibre composition.

From a yet further aspect, there is provided an air filtration device comprising at least one layer of a web of antimicrobial fibres having an antimicrobial fibre composition as defined above. The air filtration device may include other layers which do not have antimicrobial properties.

In another aspect of the invention, there is provided a process for producing antimicrobial fibres, the process comprising: a) producing an antimicrobial masterbatch, as defined above, by mixing together the first antimicrobial agent, the second antimicrobial agent and the polymer carrier, or the first antimicrobial agent, the second antimicrobial agent, the hydrophilic surface modifying agent and the polymer carrier; or the antimicrobial agent, the hydrophilic surface modifying agent and the polymer carrier; b) mixing the antimicrobial masterbatch with a polymer substrate to produce a fibre composition melt; and c) producing fibres from the fibre composition melt.

Either one or both of the mixing steps in a) or b) are performed in the melt. Preferably, both steps a) and b) are performed in the melt in a screw extruder and the fibres are formed from the fibre composition melt by extrusion. Preferably, the antimicrobial masterbatch is placed in a dry form before being mixed with the polymer substrate.

Optionally, the process includes the addition of additives in step b) such as a hydrophilic surface modifier or a colour additive. The process can further comprise meltblowing or spinbonding the fibres to produce a web of antimicrobial fibres.

Advantageously, the inventor has designed a novel antimicrobial composition of biostatic and biocidal agents which can be integrated into fibres and fabrics for manufacture into a number of end products such as filters and face masks. During normal use, the antimicrobial composition releases a combination of bioactive components having bacteriostatic and/or fungistatic properties. The composition may optionally include a surface modifier and/or other additives as a promoter to the biostatic agents or for adding other functions to the fibres and fabrics. Filter media can be made from such treated fibres and fabrics to trap and deactivate pathogenic microorganisms which may be airborne.

The antimicrobial fibres and fabrics of the present invention are capable of preventing the growth of a broad spectrum of bacteria even in the event of increased levels of microbial contamination, for example above 1,000,000 CFU in aerosols and droplets. Fibrous filter material incorporating the antimicrobial composition of the present invention has demonstrated high antimicrobial efficiency to Gram-positive bacteria within minutes and substantially suppressed bioactivity of Gram-negative bacteria. Further, face masks made of the antimicrobial fibres, fabrics or filter media of the present invention may help to control airborne infections, substantially reduce or essentially eliminate colonization of pathogenic micro-organisms on the mask and in the wearer, and prevent cross-contamination of detrimental micro-organisms between the wearer and surrounding environment. Advantageously, the inventor found that antimicrobial surgical masks according to the present invention provide the highest level of bio-protection with a Bacterial Filtration Efficacy (BFE) of 99.98% and a differential air pressure below 3 mm H₂O. Another advantage of the antimicrobial fibrous filter material of the present invention is the resulting soft fabric which ensures natural feel and close fit around the facial features thus minimizing or preventing air flow around the edges. Low air resistance is also provided which is related to more natural ease of breathing and minimizes heat generation in the breathing chamber even in the event of prolonged use.

The antimicrobial surgical masks of the present invention may be used, for example, in hospitals, healthcare facilities and any other environments where enhanced bacterial protection is recommended or required to prevent or reduce the risk of airborne infections. For example, the antimicrobial surgical masks can be used by high-risk patients with weakened or temporarily compromised immune system, visitors, healthcare professionals and support personnel in healthcare facilities who are all potential hosts of airborne pathogens and community acquired infections. The combination of mask design, advanced filtration media and natural feel fabric allows the wearer to comfortably use the face mask for extended periods and with normal breathing without a risk of cross-contamination when the environment is challenged with air-borne pathogens.

### BRIEF DESCRIPTION OF THE DRAWINGS

Further aspects and advantages of the present invention will become better understood with reference to the description in association with the following drawings in which:

FIG. 1 a illustrates a face mask comprising three layers of antimicrobial filter media according to an embodiment of the present invention;

FIG. 1b illustrates a magnified diagrammatic representation of fibres forming the filter media of the face mask of FIG. 1 a;

FIG. 2 illustrates the face mask of FIG. 1 a in (a) an expanded form, and (b) a non-expanded form;

FIG. 3 is a cross-section through the antimicrobial filter media layers of the face mask of FIG. 2;

FIG. 4 is a table representing the construction and orientation of the layers of the antimicrobial filter media of the face mask of FIGS. 1 and 2;

FIG. 5 is a cross-section through layers of antimicrobial filter media forming part of a four-layered face mask according to another embodiment of the invention;

FIG. 6 is a table representing the construction and orientation of the layers of the antimicrobial filter media of FIG. 5;

FIG. 7 illustrates a face respirator comprising five layers of antimicrobial filter media in (a) an expanded form, and (b) a non-expanded form, according to yet another embodiment of the present invention

FIG. 8 is a cross-section through the layers of the antimicrobial filter media of the face respirator of FIG. 7;

FIG. 9 is a table representing the construction and orientation of the layers of the antimicrobial filter media of the face respirator of FIG. 7;

FIG. 10 is a cross-section through layers of antimicrobial filter media forming part of a six-layered face respirator according to a yet further embodiment of the invention;

FIG. 11 is a diagrammatic representation of a dynamic bio-efficacy tester for face masks and respirators;

FIGS. 12(a) to (e) are graphs illustrating an aerosol challenge at 1,000,000 CFU inoculum of the three-layered face mask of FIG. 2 vs. a standard face mask with (a) chlamidia psittaci, (b) aspergillus niger, (c) mycobacterium bovis, (d) MRSA, and (e) B. dimunta, according to Example 4;

FIGS. 13(a) to (f) are graphs illustrating an aerosol challenge at 20,000 CFU inoculum of the face mask of FIG. 2 vs. a standard face mask with (a) chlamidia psittaci, (b) aspergillus niger, (c) M. bovis, (d) MRSA, (e) B. diminuta, and (f) P. aeruginosa, according to Example 4; and

FIG. 14 is a graph illustrating results from a Dynamic Aerosol Test (DAT) challenge at 36,000 CFU inoculum for the evaluation of the effectiveness of the face mask of FIG. 2 vs. a standard face mask against MRSA in highly concentrated droplets, according to Example 4.

### DETAILED DESCRIPTION

Definitions

Unless otherwise specified, the following definitions apply:

The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of is intended to mean including and limited to whatever follows the phrase “consisting of”. Thus the phrase “consisting of” indicates that the listed elements are required or mandatory and that no other elements may be present.

As used herein, the term “antimicrobial agent” is intended to mean a compound that inhibits, prevents or destroys the growth or proliferation of microbes such as bacteria, protozoa, viruses, moulds and the like.

As used herein, the term “bacteriostatic” or “biostatic” is intended to mean a substance which is capable of inhibiting the growth or reproduction of bacteria.

As used herein, the term “fungistatic” is intended to mean a substance which is capable of inhibiting the growth or reproduction of fungi.

As used herein, the term “bacteriocidal” or “biocidal” is intended to mean a substance which is capable of killing bacteria.

As used herein, the term “bacteriostatic agent”, “biostatic agent” or “fungistatic agent” is intended to mean an agent which has bacteriostatic, biostatic and/or fungistatic properties, respectively, depending on the effective concentration and type of microorganism. The term is used to cover a broad range of microorganisms.

The terms “microorganisms” and “microbes” are used interchangeably throughout the description and are intended to mean bacteria, fungi, and viruses. In one example of the invention, the microorganisms are airborne.

The term “fibre” as used herein refers to a unit of matter which is capable of being spun into a yarn or made into a fabric by bonding or interlacing, e.g. spinbonding, meltbonding, meltblowing, weaving, knitting, braiding, felting, twisting, webbing or otherwise fabricating into a fabric.

The term “yarn” as used herein refers to a strand or strands of fibre in a form suitable for weaving, knitting, braiding, felting, twisting, webbing or otherwise fabricating to a woven or nonwoven fabric, or a combination of both.

The term “fabric” as used herein refers to any material woven, non-woven, knitted, felted or otherwise produced from, or in combination with, a fibre, a yarn or substitute therefore.

The terms “antimicrobial fabric” or “antimicrobial filter media” as used herein refers to any material woven, non-woven, knitted, felted or otherwise produced from, or in combination with, a fibre, a yarn or substitute therefore made of fibres containing an antimicrobial composition, or a blend of fibres containing an antimicrobial composition with fibres not containing antimicrobial agents. In one example of a blend, the ratio of fibres containing antimicrobial agents to fibres without antimicrobial agents can be 5 to 95% and 95% to 5%, respectively.

The term “fibre substrate material” as used herein encompasses the bulk material of which a fibre is composed or contains.

I: Compositions

An aspect of the invention comprises antimicrobial compositions that can be incorporated into a material either before, during or after formation of a product made from that material. For example, the product can be fibres, webs, fabrics or yarns. One application of these compositions applied to fibres is in air filters, such as face masks and respirators.

The composition comprises at least two antimicrobial agents having different antimicrobial mechanisms, or at least two antimicrobial agents where one of the antimicrobial agents is capable of releasing metal ions. Advantageously, the two antimicrobial agents provide a synergistic effect in reducing or suppressing microbial growth. This means that the total volume of agents can be reduced or minimized to achieve equivalent biostatic activity.

The two antimicrobial agents can be an organic and an inorganic antimicrobial agent. Preferably, one of the antimicrobial agents is a metal ion containing agent. The antimicrobial agents can be selected based on their biostatic or biocidal effect on a relatively broad spectrum of microorganisms as well as the expected difference in their biostatic or biocidal activity mechanisms. When the composition is to be incorporated in the structure or surface of the fibre, factors such as the release mechanism of the agents and the kinetics under the expected conditions of use are taken into account.

In one embodiment of the composition, which is suitable for incorporation within a fibre during fibre formation from the melt, one of the antimicrobial agents contains metal ions, such as heavy metal ions. Once the composition is incorporated into the body of the fibre, the composition can, under moist conditions, release the metal ions such that they move towards the surface of the fibre. On contact with the moisture, at the fibre surface, the metal ions are absolved by the present microorganisms which in turn inhibits or prevents the growth of the microorganisms in contact with the fibre surface. Meanwhile, the other antimicrobial agent of the composition on the fibre surface synergistically inhibits or prevents the growth of the microorganisms in contact with the fibre surface. Advantageously, the synergistic effect of the two antimicrobial agents means that less of the individual agents is required for the same or equivalent antimicrobial effect.

In one example of this embodiment, the antimicrobial agents are Triclosan™ (a nonionic halogenated biphenyl ether compound, for example 2,4,4′-trichloro-2′-hydroxy-diphenyl-ether, (Irgaguard™ B1000, CIBA Specialty Chemicals) and an inorganic material capable of releasing metal ions, such as silver ions, which are suitable for incorporation in the melt state with a polymer fibre substrate, such as polypropylene. The inorganic antimicrobial agent can be a silver-zinc-glass such as Irgaguard™ B7000 (CIBA Specialty Chemicals), silver-zirconium-phosphate (e.g. from Milliken™), silver-zeolite (e.g. from Agion™), or nano silver compounds, nano copper compounds and nano chromium compounds. In general, these materials are ceramic type inorganic compounds or inorganic compounds that have limited solubility in water and thus could emit metal ions at a predictable rate. Instead of Triclosan™, any other suitable antimicrobial agent can also be used, such as quaternary ammonium salts, silane quaternary ammonium compounds, or organo-silver compounds. By suitable antimicrobial agent, it is meant an antimicrobial agent or agents which have an antimicrobial effect on the particular microorganisms relevant to a particular application e.g. air filters or face gear.

In another embodiment, the antimicrobial composition includes a hydrophilic surface modifier. The hydrophilic surface modifier enhances the water holding capacity of the fibre surface by creating a hydrophilic surface around the fibre such that any microorganisms that contact the fibre are initially presented with a favourable growth environment as they are attracted to moist environments. Thus, the fibre can capture and retain water naturally existing in the surrounding air. The water provides a favourable moist environment for airborne microorganisms, such that a film of surface water traps and holds the microorganisms much more effectively than untreated fibres with hydrophobic surface characteristics. The surface modifier can be any type of surface modifier which can capture and retain moisture, such as non-ionic surfactants based on low molecular weight copolymers of polypropylene characterized by amphiphilic structure. Suitable hydrophilic modifiers have a composition including linear alkyl phosphate, polyorganosiloxane composition, or amphiphilic block copolymers.

It was found that a composition comprising a silver-zinc-glass antimicrobial agent (e.g. Irgaguard™ B7000) in combination with Triclosan™ and a surface modifier (e.g. Irgasurf™ HL560 from CIBA) provided an unexpected synergistic antimicrobiocidal effect when incorporated into a polypropylene fibre substrate melt, compared to the individual components under identical test conditions. Without wishing to be held to any theory, it is thought that the surface modifier works as a promoter for the metal ion based component. When such a surface modifier is included in the antimicrobial composition, moisture is absorbed and held on the filtration media surface such that a bio-effective concentration of silver ions is released from the silver-zinc-glass antimicrobial compound of the composition to provide a higher concentration of silver ions in the hydrophilic layer of the fibres. Thus, it is thought that the combined effect of attracting and holding the microorganisms to the surface of the fibres and an increased concentration of antimicrobial agent also at the fibre surface results in a more powerful antimicrobial reaction when compared to a neat application of the individual antimicrobial agents. The extended residence time of the trapped microorganisms will allow longer reaction time for the silver ion and Triclosan™ components of the composition. Since two independent antimicrobial agents simultaneously affect the microorganisms, very little resistance is expected even in the cases of increased contamination of pathogens in the air.

Alternatively, the composition can comprise a single antimicrobial agent and a hydrophilic surface modifier. For example, the composition may comprise about 5 to about 95% by weight of Triclosan™ or silver-zinc-glass, and about 5 to about 95% by weight of a surface modifying agent such as Irgasurf™ HL560.

II: Fibres and Processes for their Manufacture

A second aspect of the invention includes fibres, fabrics, yarns and webs incorporating the composition of embodiments of the present invention and processes for their manufacture. In the case of fibres, the antimicrobial composition is incorporated within the body/matrix/substrate of the fibre or the surface of the fibre such that the composition is stable within the fibre substrate or surface material. The fibre substrate or surface material can be a polymer, such as polypropylene, polyethylene, polypropylene and polyethylene blends, polyamide, polyamide copolymers, a blend of polyamides, polyester, polyester copolymers, a blend of polyesters, polycarbonate or any combination of these polymers.

In one embodiment, the fibres are made by first preparing a masterbatch concentrate from the antimicrobial composition and a polymer carrier. The masterbatch concentrate may or may not include a hydrophilic surface modifier. The masterbatch concentrate is then mixed or blended with the fibre substrate material (polymer substrate) to form the antimicrobial fibre composition from which the fibres can be formed. If the masterbatch did not include a hydrophilic surface modifier, this may be added during the formation of the fibre composition, or it can be omitted altogether. Other additives can also be added at this stage, as well as to the masterbatch concentrate, such as those for improving processing, dispersion and colour.

The masterbatch concentrate is preferably formed by mixing together the antimicrobial composition in the melt with a polymer carrier. The fibre substrate material and the masterbatch concentrate are also mixed together when in the molten states. Therefore, the fibre substrate material and the polymer carrier are chosen according to their melting temperature and the compatibility of this melting temperature with the antimicrobial agents of the composition. However, as will be clear to skilled persons, other methods of preparing the masterbatch concentrate and mixing it with the fibre substrate are also possible and within the scope of the present application. Fibres are produced from the fibre composition in manners known in the art, such as by extrusion.

Thus, the antimicrobial agents are incorporated into the body or the surface of the fibres during the fibre formation process.

In one example of this embodiment, the fibre substrate material is polypropylene and the fibres are formed by extruding the masterbatch concentrate and polypropylene mix. The masterbatch concentrate is blended with a medical grade polypropylene feed in blending equipment such as a dual screw extruder with an appropriate melt flow rate for a polypropylene carrier.

In this example, the composition of the masterbatch concentrate contains Triclosan™ (Irgaguard™ B-1000) and silver-zinc-glass (Irgaguard™ B-7000). Preferably, the Triclosan™ and the silver- zinc glass are added 5 to 95% by weight and 95 to 5% by weight respectively, more preferably 40% Triclosan™ and 60% silver-zinc-glass.

In addition, the masterbatch concentrate can incorporate other ingredients such as polyethylene or polypropylene waxes or mixtures of low molecular polyethylene and polypropylenes with paraffin to improve additive dispersion in the resulting fibres and minimize product loss. Further, to add the desired hydrophilic characteristics of the fibres, a surface modifier, such as Irgasurf™ HL560 (CIBA Specialty Chemicals) can also be mixed with the masterbatch concentrate at from 0.5 to 5.0%, preferably in this example 2.5 to 3%, into the polymer feed stream. Desired color can be incorporated into the fibres during the manufacturing process by addition of appropriate dyes.

It will be appreciated that other processes for incorporating the antimicrobial composition into a body or surface of a fibre are also possible, as long as a substantially uniform distribution of the antimicrobial agents in the fibre body or fibre surface is achieved. The fibres can be formed into yarn or into woven or non-woven webs such as fabrics for a number of uses, for example by spinbonding, meltbonding or meltblowing, in a manner known in the art. It was found that spunbond fabrics made from fibres of the present invention appear to have a smooth and soft surface and are less prone to peeling compared to the meltblown fabrics made from fibres of the present invention due to the combined effect of the hydrophilic polymer additive (e.g. Irgasurf™ HL560) and the antimicrobial agent (e.g. Irgaguard™ B1000). By “peeling” it is meant the shedding of individual fibres or filaments from the fabric surface.

Advantageously, as the antimicrobial agents are dispersed within the fibre, the antimicrobial agents and the hydrophilic modifier do not leach off or gas off during the typical and reasonable conditions of use of the fibres and fabrics formed from the fibres, such as when they are formed into face masks and respirators. In the example of the composition comprising Triclosan^{TM} and silver-zinc-glass, the bio-active ingredients of silver ions and chlorinated biphenyl ether, are concentrated only on the hydrophilic surface of the fibres and do not migrate. It was found that only minor traces of Triclosan™ were detected when a mask made with the fibres was heated to 40° C. for 8 hours. The face mask was made to contain less than 10 mg of antimicrobial agents, while the inner fabric in close proximity with the face skin may contain only 1 mg of Triclosan™. The added antimicrobial agents cannot be extracted from the fibre or resultant fabric.

Alternatively, the antimicrobial composition of the present invention can be incorporated onto fibres, yarns or fabrics by applying the antimicrobial composition of the present invention to pre-formed fibres, yarns or fabrics such as by dipping or soaking. A combination approach of melt extrusion (spunbond, meltblown or staple fibre) of one or more fibrous filtration media and dipping or soaking of other fibrous filtration media already made as modified or commonly prepared fibrous filtration media are possible techniques under the scope of this embodiment.

III: Antimicrobial Filters

A yet further aspect of the invention comprises antimicrobial filters and filter devices, such as face masks and respirators, made from the fibres, yarns, webs, fabrics and filter media of embodiments of the present invention. The face masks, particularly surgical face masks, can be manufactured in the same manner as standard face masks using medical grade polypropylene for example. In typical manner, the face masks can comprise multiple layers of filter media. Each layer is constructed as a fine mesh (web) to trap small particles and also to absorb fine aerosols, typically having a pore size of about 0.25-5.0 microns. However, a difference of the fibres and fabrics of the present invention is that they can be made with varying amounts of antimicrobial agents and hence varied and desired levels of biostatic and biocidal activity. Therefore, the filters and face masks of the present invention can comprise layers incorporating different amounts of antimicrobial agents. All of the layers may incorporate the antimicrobial compositions of the present invention or the filters and face masks may include a combination of antimicrobial and non-antimicrobial layers. For example, face masks and respirators can be made including a total amount of all antimicrobial components in the formulation being from 0.1% to 2.0%, more preferably 0.5% by weight to minimize the potential exposure to bioactive compounds. Also, each layer can be made of fibres manufactured in a different basis weight and fabric formation to provide a number of useful and varied permutations and masks or respirators with different degrees of antimicrobial performance and filtration efficiency.

Advantageously, due to the synergistic effect of the at least two antimicrobial agents in some embodiments of the composition, filters, face masks or respirators incorporating the composition of embodiments of the present invention reduce or eliminate the need to provide high levels of bacterial filtration efficiency for trapping particulates. Instead, due to the biostatic and/or biocidal efficacy of the antimicrobial composition, the effective pore size of the filter can be enlarged and optimized to allow more air flow at lower air resistance. In fact, the inventor has found that the filters of the present invention improve the pressure drop across a face respirator by more than 20% from 10-12 mm H₂O air resistance for the common n-95 respirator to 8.0 for the 5dEZR model (see Example 1 below). When applied to surgical masks and respirators, these filters can result in lowering the temperature in the breathing chamber along with allowing for more natural breathing for extended periods. Also, there are fewer air leaks from the edges of these face masks as a result of lower air resistance through the filter and a better fit around the facial features due to the softer antimicrobial fabric.

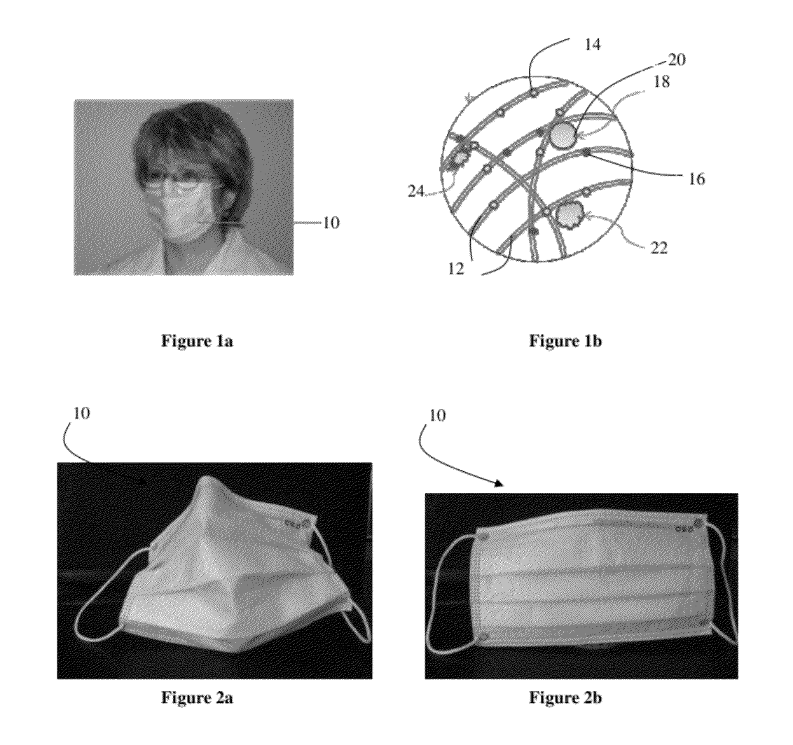

One embodiment of a face mask 10 of the present invention is illustrated in FIG. 1a together with an enlarged schematic view of one layer of the filter media of the face mask 10 comprising fibres 12 incorporating a first antimicrobial agent 14, a second antimicrobial agent 16 in FIG. 1b.

As illustrated, at a microscopic level, in a first step 18 of operation, the surface of the fibres 12 attracts and holds microorganisms 20. According to the present invention, the microorganisms are held for a longer period when compared with polypropylene fibres without the present antimicrobial composition. This is thought to be related in part to the inclusion of a hydrophilic surface modifier of the composition which creates a moisture enriched surface around each fibre of the filter media. Thus, the increased dwell time and close contact of the trapped microorganisms allows the combination of the first and second antimicrobial agents to penetrate through the microorganism cell walls and disturb their vital metabolic processes, in a second step 22 of operation. As a result, the trapped microorganisms lose their ability to function and reproduce within minutes. With time, in a third step 24, the microorganism or pathogen is inactivated or weakened due to the combined biostatic/biocidal effect of the two antimicrobial agents. In the event of an acute challenge of millions of microorganism colonies, it is thought that the population could not survive on the treated antimicrobial fibres and will thus gradually extinguish. In the rare occasions when individual microorganisms penetrate through a number of layers of fibres, it is thought that their vitality will be greatly reduced so that they cannot contaminate the host by starting a vital population.

With embodiments of the present invention, the antimicrobial agents work when the bioactive components, e.g. the silver ions and/or chlorinated biphenyl ether, penetrate the microorganism cell membrane and bind with microorganism enzymes. This mechanism is different from the biocidal effect of known disinfectants which work very quickly based on chemical reactions. Also, in the case of known filters made from hydrophobic fibres, the microorganisms could slide between the filters and eventually pass the filter with time. In this case the contact time between microorganisms and fibre is somewhat limited.

Some other embodiments of the present invention will now be described in detail in the following Examples.

### EXAMPLES

### Example 1

### Antimicrobial Surgical Masks

Three-Layer Antimicrobial Surgical Mask (3xEZ)

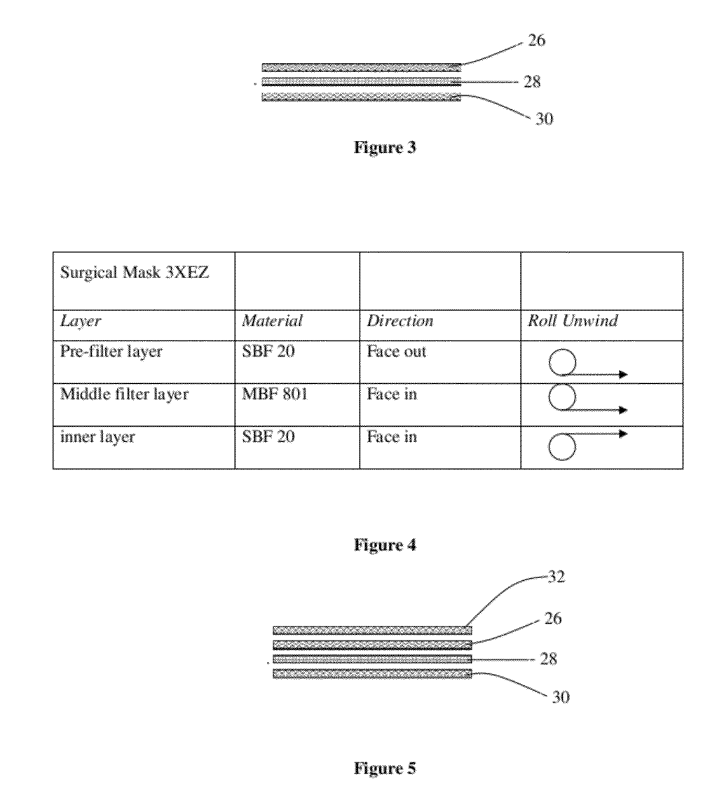

An antimicrobial surgical mask 10, code name 3xEZ, illustrated in FIGS. 2a and 2b, was manufactured according to embodiments of the present invention. Specifically, and as illustrated in FIG. 3, the antimicrobial surgical mask 3xEZ, comprised three layers of antimicrobial filter media: a pre-filter layer 26, a middle filter layer 28 and an inner layer 30. The pre-filter layer 26 was formed from spunbond fabric made of polypropylene fibres with basis weight between 15 to 65 gsm, preferably 20 gsm, and incorporating an antimicrobial composition comprising antimicrobial agents and surface modifier according to a composition of the present invention. The middle filter layer 28 was formed from meltblown fabric made of polypropylene fibres with basis weight between 15 to 60 gsm, preferably 30 gsm, and incorporating antimicrobial agents but no surface modifying agent according to a composition of the present invention. The inner layer 30 was formed from spunbond fabric made of polypropylene fibres with basis weight between 15 to 65 gsm, preferably 20 gsm, and incorporating an antimicrobial composition of the present invention including antimicrobial agents and a hydrophilic surface modifying agent.

The antimicrobial agents were Triclosan™ (Irgaguard™ B-1000, CIBA) and silver-zinc glass (Irgaguard™ B-7000, CIBA). The surface modifying agent, when used, was Irgasurf™ HL560. At a total weight of 2.14 g of the antimicrobial fabrics in the 3xEZ model, the final assembly contained about 3.4 mg of Triclosan™, about 4.3 mg of silver-zinc-glass and about 3.8 mg of the surface modifier (HL560). Each layer was formed as a roll of web and the roll position for each of the different layers of the 3XEZ surgical mask filter media is illustrated in FIG. 4 which relates to the aesthetics and prevention of loose fibres in the final mask.

The three-ply surgical masks had 3 single pleats of 1.3 cm pleat depth. The overall shape of the mask was 18.0 cm×9.0 cm with an enlarged breathing camera. Knitted elastic ear-loops or spunbond polypropylene strips were included with the face mask. Each face mask had an enclosed Aluminum nosepiece of about 12 cm×3 mm. Particulate filtration efficiency (PFE) tests of the masks measured 99.6% penetration of 0.1 micron latex particles.

It was found with this design that the fabric construction ensured better air permeability without compromising filtration efficiency. At the same level of particulate protection, the filter media of the present invention allows increased air flow in comparison with the standard MBF made of untreated polypropylene.

The masks had a more natural and comfortable feel than a standard surgical mask and the mask design and nose piece material ensured close facial fit and reduced or prevented fogging. FIG. 2a illustrates a molded breathing chamber and the smooth replica of the facial features after a user has worn the mask. It was also found that the antimicrobial fabric was soft and comfortable against the user's skin. This was thought to be due to a combination of the composition and the spinbond method used to make the fabric.

Four-Layer Antimicrobial Surgical Mask (4xEZU)

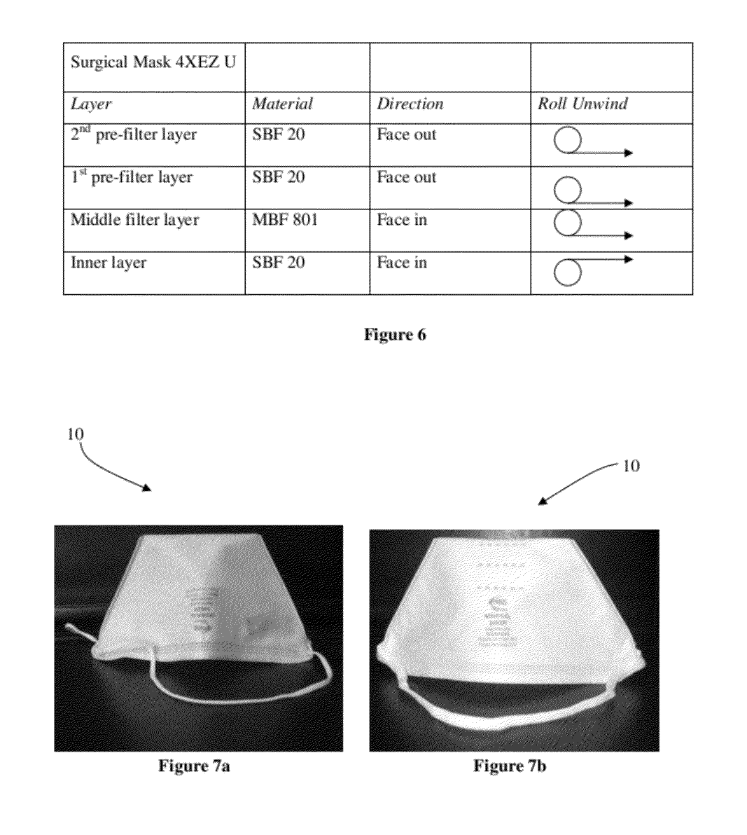

As illustrated in FIG. 5, a four-layer antimicrobial surgical mask 10, code name 4xEZU, differed from that of the three-layered surgical mask, 3xEZ, in that it comprised a second pre-filter layer 32 on the outside of the mask 10 formed from spunbond fabric (SBF). The second pre-filter layer 32 comprised fibres made from a polypropylene substrate and an antimicrobial composition according to an embodiment of the invention with basis weight between 15 to 65 gsm, preferably 22 gsm. The fibres incorporated antimicrobial agents in a ratio of Triclosan™ (B1000) to silver zinc glass (B7000) of 40/60% by weight. This mask passed the 160 mm Synthetic Blood Resistance tests (ASTM 2101) and therefore had a high fluid resistance. FIG. 6 illustrates the construction and orientation of the roll layers of the antimicrobial fibrous filter media for the 4xEZU model surgical mask of FIG. 5.

Five-Layer Antimicrobial Surgical Respirator (5dEZR/N-95 Type)

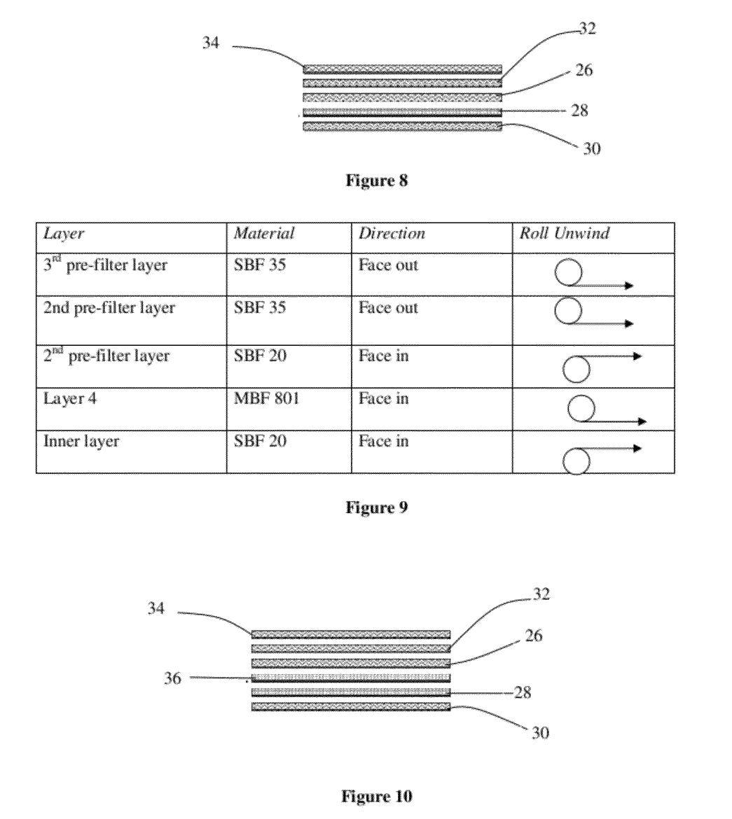

As illustrated in FIGS. 7 to 9, a five-layer antimicrobial surgical respirator 10, code name 5dEZR/N-95 type, differed from the four-layer mask 4xEZU in that it comprised a third pre-filter layer 34 on the outside of the mask 10 formed from spunbond fabric made of fibres of a polypropylene substrate and an antimicrobial composition according to an embodiment of the present invention with basis weight between 15 to 65 gsm, preferably 34 gsm. The fibres incorporated antimicrobial agents in a ratio of Triclosan™ (B1000) to silver-zinc-glass (B7000) of 40/60% by weight. This mask was found to be suitable as a N-95 type surgical respirator. FIG. 9 is a table representing the construction and orientation of the filter media layers for the 5dEZR surgical respirator 10.

Six-Layer Antimicrobial Surgical Mask (9HER/N-99 Type)

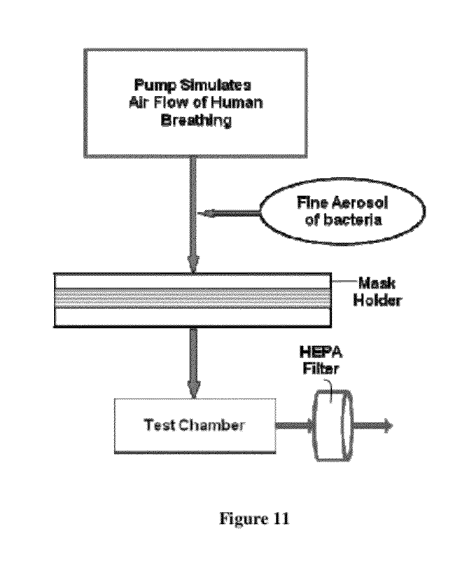

As illustrated in FIG. 10, a six-layer antimicrobial surgical mask 10, code name 9HER/N-99 type, differed from the five-layer mask 5dEZR/N-95 type in that it comprised a second middle filter layer 36 formed from meltblown fabric made of fibres of polypropylene and antimicrobial composition according to an embodiment of the invention with a basis weight of 15 to 66 gsm, preferably 30 gsm. The fibres incorporated antimicrobial agents in a ratio of Triclosan™ (B1000) to silver zinc glass (B7000) of 40/60% by weight. This mask was found to be suitable as a high efficiency N-99 type surgical respirator.

It will be clear to a skilled person that other variations and permutations of the layered masks are possible. Details of the method of manufacture of the different layers are provided in Example 2 below.

### Example 2

### Methods of Manufacture of the Multi-Layered Surgical Masks and Respirators of Example 1

### Example 2A

### Masterbatch—Making a Concentrate of Antimicrobial Agents

Since different fabric types were used for the construction of the face masks and respirators of Example 1, the desired level and formulation of antimicrobial agents were dispersed in polymer carrier with specific melt viscosity at the fibre processing temperatures. Thus, to make a masterbatch (MB) for the polypropylene (PP) spunbond fabric, about 5 parts of Irgaguard™ B7000 and about 5 parts of Irgaguard™ B1000 were fed as powder to about 90 parts of polypropylene molten resin at the middle zone of a co-rotated dual screw extruder. The temperature profile was tuned for a 35 melt flow rate polypropylene resin and started from about 190° C. at the polypropylene resin feeding port and was increased stepwise to about 225 to 245° C. at the mixing zone and extruder die. A water trough chilled the extruded antimicrobial polymer fibres (strands) to about 75° C., then an air knife removed the residual water and pelletized the material. The final spunbond masterbatch was formulated by dry mixing about 35 parts of the hydrophilic surface modifier, Irgasurf™ HL560, as 50% concentrate of the active ingredients in a 35 melt flow rate polypropylene resin, and about 65 parts of the antimicrobial masterbatch described above.

To make a masterbatch for the meltblown polypropylene fibres, about 5 parts of Irgaguard™ B 7000 and about 5 parts of Irgaguard™ B 1000 were fed as a powder to about 90 parts of polypropylene molten resin at the middle zone of a co-rotated dual screw extruder. The temperature profile was adjusted for a 50/50 mix of 800 melt flow index (MFI) polypropylene resin and 1100 melt flow rate polypropylene resin. At the feeding port the zone temperature was set to about 160° C. and then was increased stepwise to about 235° C. at the mixing zone and extruder die. A water trough chilled the polymer fibres (strands) to about 65° C., then an air knife removed the residual water and pelletized the material. In this embodiment, a surface modifier was not added to the meltblown masterbatch but can be added if desired.

### Example 2B

### Making of Spunbond Fabric (SBF)

Spunbond fabric incorporating the composition of embodiments of the present invention were made by feeding 5.5 parts of the dry mixed antimicrobial masterbatch including the surface modifier, 0.5 parts of a color additive, and 94 parts of 35 melt flow rate polypropylene resin (Basell medical grade PH 835) to the first zone of single screw extruder. To ensure uniform distribution of the antimicrobial additives, the temperature profile was set from 185° C. at the feed to 205° C. in the middle zones, and 195° C. at the adapter zone. The spinheads were heated to 205° C., while the die temperature was between 215 and 225° C. The extruded fibres were quenched with 18° C. air in a cooling chamber and deposited onto a collecting conveyor in a uniform random manner. Before slicing the fabric to the specified width, the formed web was calendared at 215° C. and 360 psi pressure. Spunbond fabric with different fabric weight was produced by controlling the extruder throughput and the take-up speed of take-up equipment.

### Example 2C

### Making of Meltblown Fabric (MBF)

To produce meltblown antimicrobial filtration media, 5.0 parts of the meltblown masterbatch was mixed with 95 parts of a 1200 melt flow rate polypropylene resin (Basell grade MF650F), and fed to a single screw extruder. The temperature profile was designed to produce a polymer melt with desired viscosity, where Zone 1 was heated to 130° C., Zone 2 to 200° C., Zone 3 to 225° C., and Zone 4 to 220° C. At the extrusion die the temperature was maintained at 225° C. The extruded filaments were further attenuated in high velocity air at 225° C. To obtain the desired web porosity, the collecting screen was placed about 8 to 10 inches from the die while the secondary cold air flow was applied in perpendicular direction to create sufficient turbulence. The solidified fibres were laid randomly onto a porous conveyor and formed a self-bonded web of 3-5 micron fibre diameter. Vacuum was applied to the porous belt to maintain product uniformity. For a specific fabric weight, the collector speed was controlled in a synchronized manner with other process parameters to avoid accumulation of excessive heat, fabric stiffness and compromised air filtration efficiency.

### Example 2D

### Mask and Respirator Assembly

To assemble the mask and the respirators of Example 1, spunbond and meltblown fabrics of different antimicrobial properties were prepared and were die cut to design patterns. The layer sequencing and type of layer used depended on the intended use and expected product performance. Orientation of the layers also has an effect on filter performance and lint formation.

### Example 3

### Performance Evaluation of the Three-Layer Mask, 3xEZ, of Example 1

The three-layer surgical mask, 3xEZ, was submitted for a standard evaluation in compliance with ASTM 2100 protocols and FDA requirements (Surgical Masks—Premarket Notification [510(k)] Submission; Guidance for Industry and FDA, www.fda.gov/cdrh/ode). According to the accepted ASTM protocols, the 3xEZ surgical mask demonstrated superior antimicrobial and filtration performance, unmet by any surgical mask on the market at the present time. For example, the bacterial filtration efficiency at increased challenge of 1,000,000 CFU was above 99.98%, similar to the viral filtration efficiency at increased challenge of 5,000,000 PFU—99.97% minimum. Latex particles of 0.1 microns were found to be filtered with 99.5% efficiency. Other specifications, according to ASTM 2100 standard performance evaluations, were found to be met. The 3xEZ masks met the Fluid Penetration Resistance test (ASTM F 1862) at 120 mm Hg, whilst the 4xEZU models were designed as high fluid resistance grade to meet the 160 mm Hg criteria of ASTM F1862. It will be clear to skilled persons that the other masks and respirators of Example 1 will all pass the 160mm Hg test due to the construction equivalence with 4xEZU model. The 3xEZ and 4xEZU masks were categorized as Class 1 devices based on the standard flammability test (ASTM F21000). The cytotoxicity test resulted in zero reactivity and the irritation and sensitization ISO tests were both negative according to ISO 10993 standards.

Antimicrobial Efficiency

Bacterial Filtration Efficiency (BFE): >99.98%

Virus Filtration Efficiency (VFE): >99.97%

Performance filtration tested at 50× the standard

Filtration Efficiency

Differential Pressure (DP): 2.8 mm H₂O

Particulate Filtration Efficiency (PFE): >99.6% challenged with 0.1 um particles

Fluid Resistance/Synthetic Blood: 120 mm Hg pressure

Textile Flammability: Class 1

All tests conducted in compliance of ASTM 2100 requirements and FDA (CDRH) guidance

Bio Compatibility

Cytotoxicity: Grade 0—no cell lysis/MEM elution

Dermal Irritation: 0 Primary Skin Irritation Index

Dermal Sensitization: No response observed

Tests performed in compliance of ISO10993 requirements.

To address the practical concerns of short term antimicrobial performance, a protocol simulating active human breathing was developed and is illustrated in FIG. 11. Mask samples of the 3xEZ model were challenged with several million colonies of Brevundimonas diminuta (19146). This organism, 0.22 μm in size, was chosen to imitate a very small microbe or virus cluster. Comprising antimicrobial fabrics in all layers of the mask, the mask is designed not just to filter the microorganisms, but to cause severe damage to their membrane morphology and interfere with vital cell functions, thus hamper further growth and reproduction. This is a result of the combined effect of the antimicrobial agents of the present composition. It is thought that the active ingredients of silver ions and chlorinated biphenyl ether may cause changes to the cell membrane, thus the microorganisms cannot function normally. If individual microorganisms pass through the face mask layers, they are most likely inactivated and unable to inoculate a new population. This phenomenon was observed in 15, 30 and 60 minutes of the challenging session. Consequently, in contrast with regular surgical masks known in the prior art where trapped microorganisms could reside for an extended period of time and reproduce, the 3xEZ surgical masks will remain inherently bio-safe even beyond the useful lifecycle of the product.

Furthermore, based on adapted ASTM F2100 in vitro studies with methicillin-resistant Staphylococcus aureus (MRSA; ATCC 3591), the antimicrobial masks might help to reduce the spread of hospital acquired infections as part of the standard hygiene and infections prevention protocols. The test data on bacterial (BFE) and viral filtration efficiency (VFE) at increased challenges practically reached 100% protection, which suggested that the antimicrobial surgical masks might be the most effective face mask for general public population in cases of epidemic outbreaks.

### Example 4

### Dynamic Air Test (DAT) for Evaluation of Antimicrobial Efficiency of 3xEZ Surgical Masks by Simulation of Aerosol Contamination with Clinically Important Pathogens

Biotest Protocol

Mask sample fabrics from the 3xEZ model face mask were challenged against six groups of microorganisms that are considered to be inhalational and colonization threats in hospitals and health-care settings. The two stage Anderson Impactor (see for example “Precision of the All-Glass Impinger and the Andersen Microbial Impactor for Air Sampling”, APPLIED AND ENVIRONMENTAL MICROBIOLOGY, August 1981, p. 222-225) was selected for this evaluation as the best means of challenging the protective surgical masks in a manner that more realistically mimics the actual scenario in which these pathogens would be threatening the wearer. Moreover, the Anderson Impactor can be sterilized easily, the flow rate can be verified, and it more closely mimics inhalation and subsequent human lung deposition. A nebulizer was used to deliver the infection dose of pathogens required to challenge the mask materials. The nebulizer, Pro/Neb Ultra II, can deliver 10 L/min directly in the Anderson orifice. The system was run for 35 minutes at a rate of 1 cfm (cubic foot per minute) which was verified using a gas meter attached to the pump before the system was run.

The materials from the test were aseptically removed with gloved hands, cut, and placed in a Petri dish at about 33° C. for a specified amount of time (15 min, 30 min, 60 min, 3 hours). The Petri dish had droplets of sterile water placed throughout to yield extra humidity within the incubating environment. After the proposed incubating time was reached, the material was removed from the dish and submerged in 99 ml tryptic soy broth (or whichever media is optimal for the microorganism to be recovered). The bottle of media was shaken slowly for at least 15 minutes and serial dilutions were made from this bottle. Serial dilutions (in phosphate buffered saline (PBS) or Tryptic Soy Broth (TSB)) were made down to 10⁻⁵. One ml aliquots were pour-plated into sterile Petri dishes and molten agar (about 20 to 24 ml) was placed over the aliquot and allowed to solidify. Plates were placed in an incubator at the optimal temperature of the recoverable organism. After at least 24 hours there was noticeable growth detected on plates, but 3 to 5 days was considered a sufficient growing period for most bacteria. Five to seven days is optimal for fungi and some fastidious organisms may require more time to grow. After the colonies have grown, counts were determined according to dilution that elicited the countable colonies and the data were recorded as Log Recovery of colony formatting units (CFU). To eliminate the noise variations, an average value of three samples tested at the same conditions was reported. Positive and negative controls were examined to determine the accuracy of the challenge and the inhibitory efficiency of the treated materials.

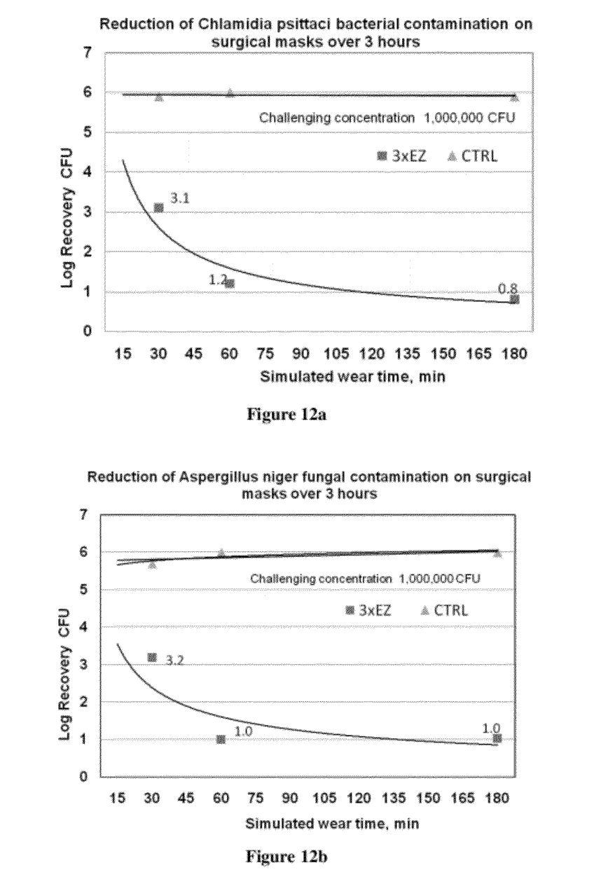

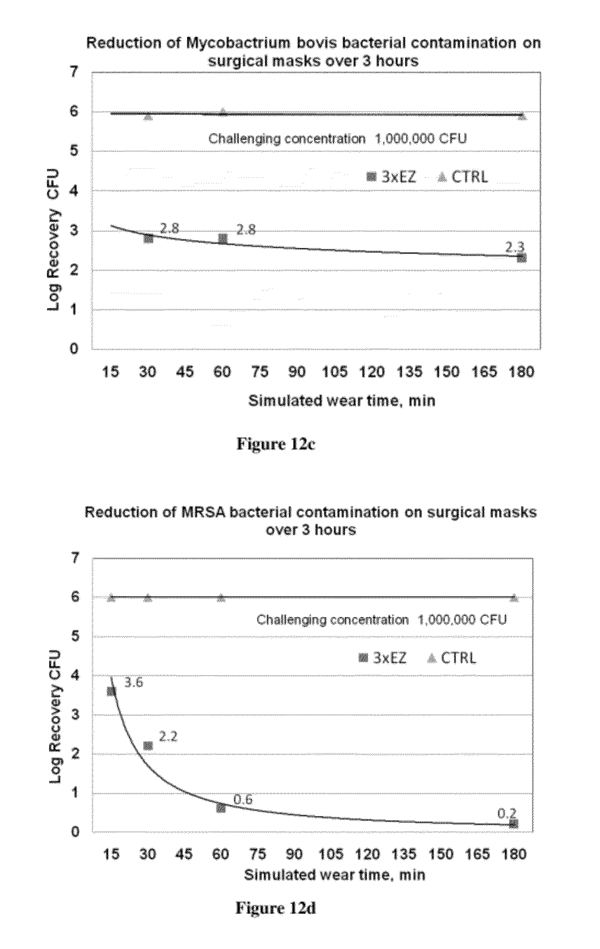

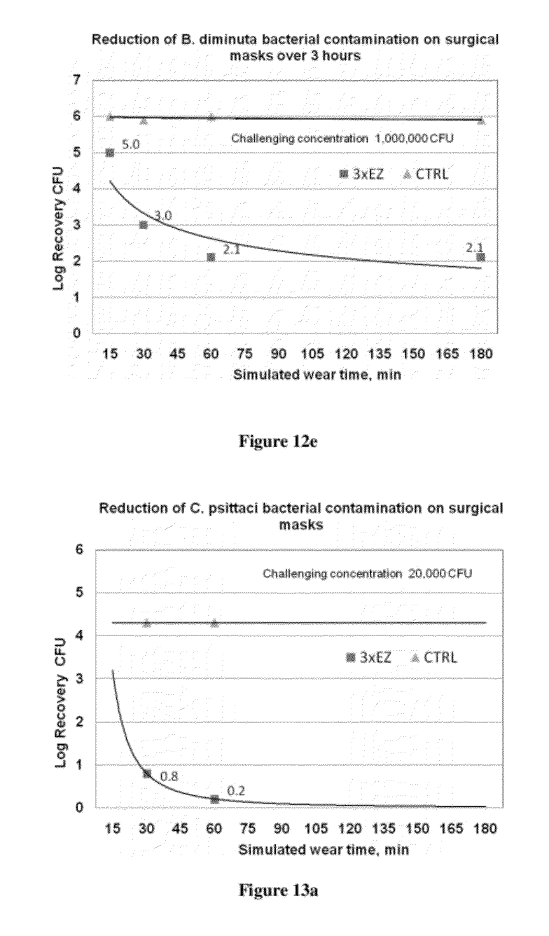

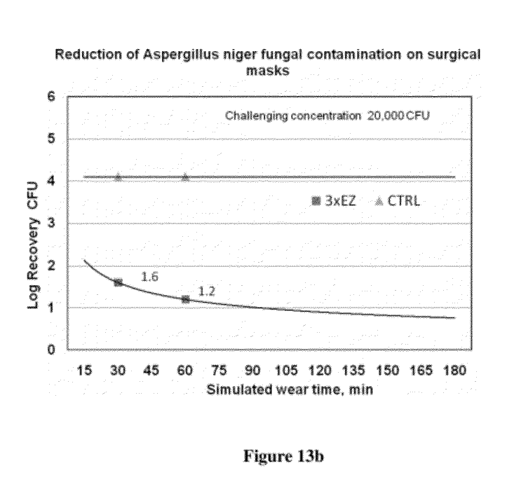

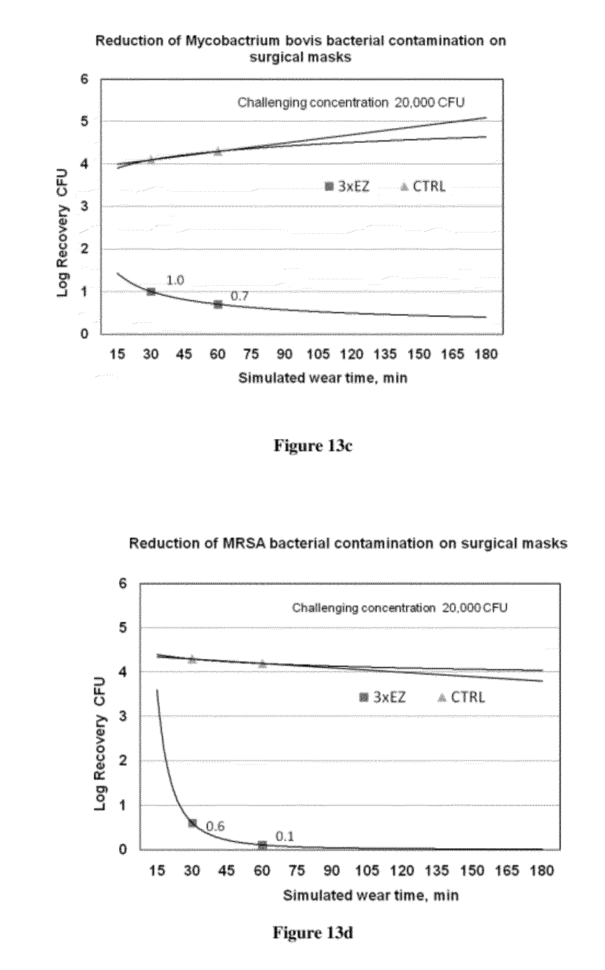

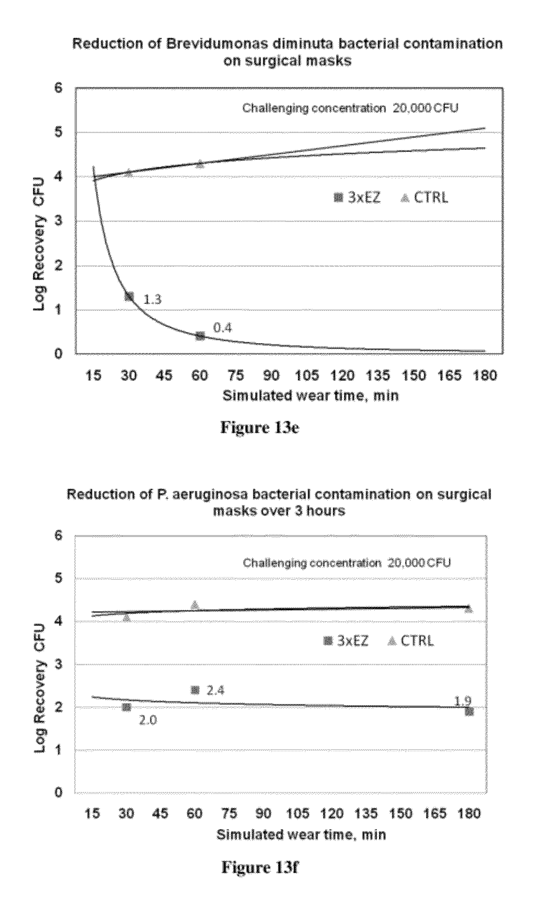

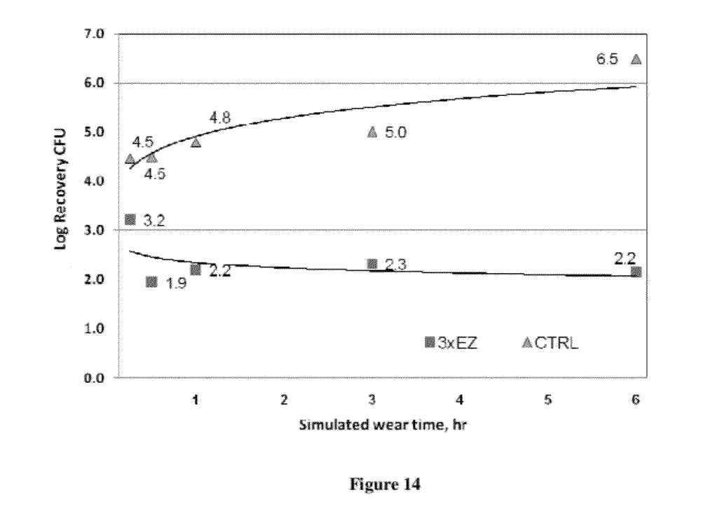

The results of DAT evaluation of six clinical pathogens dispersed in a fine mist are illustrated in FIGS. 12 and 13 as Log Recovery of CFU. In a separate test, the mask was challenged with larger droplets of MRSA spray at twice the typical infectious level and the results are illustrated in FIG. 14. This test simulated the more common scenario of spreading infectious disease by sneezing and coughing and demonstrated the practical potential of the antimicrobial mask to provide reliable protection for several hours.

Each organism type of the selected pathogens has a different growth pattern not confirmed in this example. Therefore, it could be implied that the antimicrobial agents would have a specific rate of bio-reaction response revealed by the difference in slopes of the trend lines of Log Reduction data in FIGS. 12 to 14.

A log 2 reduction corresponds to 99% actual reduction in the number of pathogen colonies, and log 3 reduction corresponds to 99.9% actual reduction. Accepted level of bio protection in most cases is above 99% reduction. Based on the accuracy of the applied test methodology Log 2 can be adapted as an internal standard for evident antimicrobial performance, and Log 3 as criteria for significant antimicrobial performance.

Background of Tested Microorganisms:
1. Chlamydia psittaci: is a lethal intracellular bacterial species that causes endemic avian chlamydiosis, epizootic outbreaks in mammals, and respiratory psittacosis in humans. Chiamydophila psittaci is transmitted by inhalation. Ref: Brock Biology of Microorganisms. 10th ed. Upper Saddle River, N.J.: Prentice Hall, 2003.
2. Aspergillus niger: A fungus and one of the most common species of the genus Aspergillus. It causes a disease called black mold. It is ubiquitous in soil and is commonly reported from indoor environments. Ref: Common and important species of fungi and actinomycetes in indoor environments. In: Microorganisms in Home and Indoor Work Environments. New York: Taylor & Francis, pp. 287-292, 2001.
3. BCG strain of Mycobacterium bovis: Mycobacterium bovis is a slow-growing aerobic bacterium and the causative agent of tuberculosis in cattle. Related to M. tuberculosis—the bacteria which causes tuberculosis in humans—M. bovis can also jump the species barrier and cause tuberculosis in humans. Ref: CDC and Prevention “Human tuberculosis caused by Mycobacterium bovis—New York City, 2001-2004,” MMWR Morb Mortality Weekly, 54: 605-8, 2005.
4. MRSA: S. aureus most commonly colonizes the anterior nares (the nostrils) although the respiratory tract, open wounds, intravenous catheters and urinary tract are also potential sites for infection. MRSA infections are usually asymptomatic in healthy individuals and may last from a few weeks to many years. Patients with compromised immune systems are at significantly greater risk of a symptomatic secondary infection. Carriers can transmit the organism easily through droplets. Ref: “Dissemination of new methicillin-resistant Staphylococcus aureus clones in the community”. Journal of Clinical Microbiology 40 (11): 4289-94, 2002.
5. Pseudomonas strain (Brevidumonas dimunuta): It was proposed in 1967 that P. diminuta (recently reclassified as Brevundimonas diminuta) should become the industry standard organism for 0.2 μm filters. In 1987, the FDA ‘Guidelines on sterile drug products produced by aseptic processing’ incorporated P. diminuta as the standard challenge organism for a sterilizing filter and defined a minimum qualifying level of 10⁷/cm² of filter area. Ref: www.pall.com
6. Pseudomonas aeruginosa: P. aeruginosa (ATCC 27853) is commonly known as the causative agent of many infections acquired in the hospital and very difficult to treat. It is relevant to use this test organism because many medical devices and cleaning agents are colonized in the hospital environment. The test material can be used as a mask that can prevent further spread of this organism to un-colonized patients. Ref: European Pharmacopoeia Commission. Efficacy of antimicrobial preservation. Strasbourg, France: European Pharmacopoeia Commission; European Pharmacopoeia EP 5.1.3, 1997.

FIGS. 12a to 12e illustrate the aerosol challenge of the antimicrobial 3xEZ mask vs. a standard surgical mask (CTRL) with hospital related infections. The standard surgical mask was made in the same manner as the 3xEZ mask but without any antimicrobial composition. The performance of the antimicrobial surgical mask was challenged with an elevated infectious level of pathogens. FIG. 12a illustrates that after 30 min the desired level of protection is reached for the C. psittaci pathogen and maintained at steady rate thereafter. FIG. 12b illustrates a relatively quick reduction and strong biostatic reaction after 60 minutes for A. niger. FIG. 12c illustrates an acceptable level of log 3 reduction being maintained throughout the test period for M. bovis. FIG. 12d illustrates a significant reduction after 30 minutes for MRSA. FIG. 12e illustrates a significant reduction after 60 minutes for B. diminuta. Note. P. aeruginosa, graph was not available as there was no growth and no reduction at the elevated level, however, such high level of contamination is not practically applicable.

FIGS. 13a to 13f illustrate an aerosol challenge of the antimicrobial 3xEZ surgical masks of the present invention vs. a standard surgical mask (CTRL) with hospital related infections. Performance of antimicrobial surgical mask challenged with a nominal infectious level of pathogens. FIG. 13a illustrates a significant reduction in the first 15 minutes of C. psittaci. FIG. 13b illustrates a significant reduction, 99.99% efficacy after the first 30 minutes for A. niger. FIG. 13c illustrates a significant reduction in the first 15 minutes for M. bovis. FIG. 13d illustrates a significant reduction, almost elimination, all MRSA colonies. FIG. 13e illustrates a significant reduction after the initial 30 minutes for B. diminuta. FIG. 13f illustrates suppression of the growth of P. aeruginosa after acceptable reduction from the infection level

FIG. 14 illustrates results from the Dynamic Air Test (DAT) for the evaluation of the effectiveness of the 3xEZ antimicrobial mask of the present invention vs. a control untreated mask against MRSA in highly concentrated droplets. This test is conducted by following a standard DAT protocol with the exception of spraying larger droplets of MRSA as may be the case during sneezing and coughing. The data clearly demonstrates that even a higher concentration of MRSA in one particular spot of the antimicrobial mask did not compromise its effectiveness for a duration of 6 hours. In contrast, the control mask actually resulted in progressive growth of MRSA microorganisms at almost 100 times the original infectious level for the same period.

All literature, patents, published patent applications cited herein are hereby incorporated by reference.

It should be appreciated that the invention is not limited to the particular embodiments described and illustrated but includes all modifications and variations falling within the scope of the invention as defined in the appended claims. For example, although the antimicrobial fibres and filter material have been described as comprising Triclosan™ and silver-zinc-glass as first and second antimicrobial agents, the antimicrobial fibres and filter material of the present invention can include any other suitable antimicrobial agents as long as one of the antimicrobial agents is capable of releasing metal ions, or as long as the two antimicrobial agents have different mechanisms of action. Similarly, the hydrophilic surface modifier has been described as being that of Irgasurf™ HL560, although any other hydrophilic surface modifier may be used.

1. An antimicrobial composition, comprising a first antimicrobial agent capable of releasing a metal ion, and a second antimicrobial agent, the first and second antimicrobial agents being in amounts that together provide a synergistic antimicrobial effect.

2. An antimicrobial composition according to claim 1, wherein the first antimicrobial agent comprises silver-zinc-glass and the second antimicrobial agent comprises Triclosan™.

3. An antimicrobial composition according to claim 2, comprising about 5 to about 95% by weight silver-zinc-glass and about 5 to about 95% by weight Triclosan™.

4. An antimicrobial composition according to claim 3, comprising about 60% by weight silver-zinc-glass and about 40% by weight Triclosan™.

5. An antimicrobial composition according claim 1 or claim 2, further comprising a hydrophilic surface modifying agent.

6. An antimicrobial composition according to claim 5, wherein the antimicrobial composition comprises about 5 to about 99.9% by weight of the first and second antimicrobial agents and about 0.1 to about 95% by weight of the hydrophilic surface modifying agent.

7. An antimicrobial composition, comprising at least two antimicrobial agents having different antimicrobial mechanisms of action and being present in amounts that together provide a synergistic antimicrobial effect.

8. An antimicrobial composition according to claim 7, wherein the at least two antimicrobial agents comprise a first antimicrobial agent which is organic and a second antimicrobial agent which is inorganic.

9. An antimicrobial composition according to claim 7 or claim 8, wherein at least one of the first or the second antimicrobial agents is a metal ion releasing agent.

10. An antimicrobial composition according to claim 9, wherein the first antimicrobial agent comprises Triclosan™ and the second antimicrobial agent comprises silver-zinc-glass.

11. An antimicrobial composition according to claim 10, comprising about 5 to about 95% by weight silver-zinc-glass and about 5 to about 95% by weight Triclosan™.

12. An antimicrobial composition according to claim 11, comprising about 60% by weight silver-zinc-glass and about 40% by weight Triclosan™.

13. An antimicrobial composition according to claim 7, further comprising a hydrophilic surface modifying agent.

14. An antimicrobial composition according to claim 13, comprising about 5 to about 99.9% by weight of the first and second antimicrobial agents and about 0.1 to about 95% by weight of the hydrophilic surface modifying agent.

15. An antimicrobial composition, comprising an antimicrobial agent and a hydrophilic surface modifying agent.

16. An antimicrobial composition according to claim 15, wherein the antimicrobial agent is capable of releasing a metal ion.

17. An antimicrobial composition according to claim 16, wherein the antimicrobial agent comprises silver-zinc-glass.

18. An antimicrobial composition according to claim 15, wherein the antimicrobial agent comprises Triclosan™.

19. An antimicrobial composition according to claim 15, comprising about 5 to about 95% by weight of the surface modifying agent and about 5 to about 95% by weight of the antimicrobial agent; preferably about 15 to about 20% of the antimicrobial agent and about 80 to about 85% of the surface modifying agent.

20. An antimicrobial masterbatch for making antimicrobial polymers, the masterbatch comprising a polymer carrier, a first antimicrobial agent capable of releasing a metal ion, and a second antimicrobial agent, the first and second antimicrobial agents being in amounts that together provide a synergistic antimicrobial effect.

21. An antimicrobial masterbatch according to claim 20, comprising about 2.5 to about 35.0% by weight of the first antimicrobial agent, about 2.5 to about 35% by weight of the second antimicrobial agent, and about 95% to about 30% by weight of the polymer carrier.

22. An antimicrobial masterbatch according to claim 21, comprising about 5% by weight of the first antimicrobial agent, about 5% by weight of the second antimicrobial agent, and about 90% by weight of the polymer carrier.

23. An antimicrobial masterbatch according to claim 20, further comprising a hydrophilic surface modifying agent.

24. An antimicrobial masterbatch according to claim 23, comprising about 2.5 to about 35% by weight of the first antimicrobial agent, about 2.5 to about 35% by weight of the second antimicrobial agent, about 5 to about 45% by weight of the hydrophilic surface modifying agent, and about 50% to about 95% by weight of the polymer carrier.

25. An antimicrobial masterbatch according to claim 24, comprising about 6.5% by weight of the first and second antimicrobial agents, about 35% by weight of the hydrophilic surface modifying agent, and about 58.5% of the polymer carrier.

26. An antimicrobial masterbatch according to claim 20, wherein the polymer carrier comprises polypropylene, the first antimicrobial agent comprises silver-zinc-glass and the second antimicrobial agent comprises Triclosan™.

27. An antimicrobial masterbatch for making antimicrobial polymers, the masterbatch comprising a polymer carrier, and at least two antimicrobial agents having different antimicrobial mechanisms of action and being present in amounts that together provide a synergistic antimicrobial effect.

28. An antimicrobial masterbatch according to claim 27, wherein the at least two antimicrobial agents comprise a first antimicrobial agent which is organic and a second antimicrobial agent which is inorganic.

29. An antimicrobial masterbatch according to claim 27, wherein at least one of the first and second antimicrobial agents is a metal ion releasing agent.

30. An antimicrobial masterbatch according to claim 27, comprising about 2.5 to about 35.0% by weight of the first antimicrobial agent, about 2.5 to about 35% by weight of the second antimicrobial agent, and about 95% to about 30% by weight of the polymer carrier.

31. An antimicrobial masterbatch according to claim 30, comprising about 5% by weight of the first antimicrobial agent, about 5% by weight of the second antimicrobial agent, and about 90% by weight of the polymer carrier.

32. An antimicrobial masterbatch according to claim 27, further comprising a hydrophilic surface modifying agent.

33. An antimicrobial masterbatch according to claim 32, comprising about 2.5 to about 35% by weight of the first antimicrobial agent, about 2.5 to about 35% by weight of the second antimicrobial agent, about 95 to 45% by weight of the hydrophilic surface modifying agent, and about 50% to about 95% by weight of the polymer carrier.

34. An antimicrobial masterbatch according to claim 33, comprising about 6.5% by weight of the first and second antimicrobial agents, about 35% by weight of the hydrophilic surface modifying agent, and about 58.5% of the polymer carrier.

35. An antimicrobial masterbatch according to claim 27, wherein the polymer carrier comprises polypropylene, the first antimicrobial agent comprises silver-zinc-glass and the second antimicrobial agent comprises Triclosan™.

36. An antimicrobial masterbatch for making antimicrobial polymers, the masterbatch comprising an antimicrobial agent, a hydrophilic surface modifying agent and a polymer carrier.

37. An antimicrobial masterbatch according to claim 36, wherein the antimicrobial agent is capable of releasing a metal ion.

38. An antimicrobial masterbatch according to claim 37, wherein the antimicrobial agent comprises silver-zinc-glass.

39. An antimicrobial masterbatch according to claim 36, wherein the antimicrobial agent comprises Triclosan™.

40. An antimicrobial masterbatch according to claim 36, comprising about 5 to 45% by weight of the hydrophilic surface modifying agent, about 5 to 70% by weight of the antimicrobial agent, and about 50 to 90% by weight of the polymer carrier, preferably 35% by weight of the hydrophilic surface modifying agent, about 7% by weight of the antimicrobial agent, and about 52% by weight of the polymer carrier.

41. An antimicrobial fibre composition for making antimicrobial fibres, the composition comprising an antimicrobial masterbatch according to claim 20, and a polymer substrate.

42. An antimicrobial fibre composition according to claim 41, comprising about 1 to 20% by weight of the antimicrobial masterbatch, and about 80 to 99% by weight of the polymer substrate.

43. An antimicrobial fibre composition according to claim 41, comprising about 5% by weight of the antimicrobial masterbatch, and about 95% by weight of the polymer substrate.

44. An antimicrobial fibre composition according to claim 41, further comprising a hydrophilic surface modifier.

45. An antimicrobial fibre composition according to claim 44, comprising about 1 to 20% by weight of the antimicrobial masterbatch, about 1 to 15% by weight of the hydrophilic surface modifier, and about 98 to 65% by weight of the polymer substrate.

46. An antimicrobial fibre composition according to claim 44, comprising about 5% by weight of the antimicrobial masterbatch, about 3% by weight of the hydrophilic surface modifier, and about 92% by weight of the polymer substrate.

47. An antimicrobial fibre composition for making antimicrobial fibres, the composition comprising an antimicrobial masterbatch according to claim 23, and a polymer substrate.

48. An antimicrobial fibre composition according to claim 47, comprising about 1 to 35% by weight of the antimicrobial masterbatch, and about 99 to 65% by weight of the polymer substrate.

49. An antimicrobial fibre composition according to claim 47, comprising about 8% by weight of the antimicrobial masterbatch, and about 92% by weight of the polymer substrate.

50. An antimicrobial fibre composition for making antimicrobial fibres, the composition comprising an antimicrobial masterbatch according to claim 36, and a polymer substrate.

51. An antimicrobial fibre composition according to claim 50, comprising about 1 to 30% by weight of the antimicrobial masterbatch, about 99 to 70% by weight of the polymer substrate.

52. An antimicrobial fibre composition according to claim 51, comprising about 8% by weight of the antimicrobial masterbatch, and about 92% by weight of the polymer substrate.

53. An antimicrobial fibre comprising a fibre body or a fibre surface having an antimicrobial fibre composition as defined in claim 41.

54. An antimicrobial filter media comprising a web of antimicrobial fibres having an antimicrobial fibre composition of claim 41.

55. A face mask comprising a plurality of layers of the antimicrobial filter media of claim 54.

56. A face mask according to claim 55, wherein at least two of the layers comprise a different antimicrobial fibre composition.

57. An air filtration device comprising at least one layer of a web of antimicrobial fibres having an antimicrobial fibre composition of claim 41.

58. A process for producing antimicrobial fibres, the process comprising:
a) producing an antimicrobial masterbatch according to claim 20, by mixing together the first antimicrobial agent, the second antimicrobial agent and the polymer carrier;
b) mixing the antimicrobial masterbatch with a polymer substrate to produce a fibre composition melt; and
c) producing fibres from the fibre composition melt.

59. A process according to claim 58, further including a hydrophilic surface modifying agent in step b).

60. A process for producing antimicrobial fibres, the process comprising:
a) producing an antimicrobial masterbatch according to claim 23, by mixing together the first antimicrobial agent, the second antimicrobial agent, the hydrophilic surface modifying agent and the polymer carrier;
b) mixing the antimicrobial masterbatch with a polymer substrate to produce a fibre composition melt; and
c) producing fibres from the fibre composition melt.

61. A process for producing antimicrobial fibres, the process comprising:
a) producing an antimicrobial masterbatch according to claim 36 by mixing together the antimicrobial agent, the hydrophilic surface modifying agent and the polymer carrier;
b) mixing the antimicrobial masterbatch with a polymer substrate to produce a fibre composition melt; and
c) producing fibres from the fibre composition melt.

62. A process according to claim 58, wherein the either one or both of the mixing steps in a) or b) are performed in the melt.

63. A process according to claim 62, wherein either one or both of the mixing steps in a) or b) are performed in a screw extruder.

64. A process according to any claim 58, wherein the fibres are produced from the fibre composition melt by melt extrusion.

65. A process according to claim 58, wherein the masterbatch is placed in a dry form before being mixed with the polymer substrate.

66. A process according to claim 58, wherein step b) further includes adding a colour additive.

67. A process according to claim 58, further comprising meltblowing or spinbonding the fibres to produce a web of antimicrobial fibres.
